(19) United States
(12) Patent Application Publication
(10) Pub. No.: US 2008/0181240 A1
(43) Pub. Date: Jul. 31, 2008

(54) System and method of CPE stored data collection

(75) Inventors: Baofeng Jiang, Pleasanton, CA (US); Kaiyan Chen, Pleasanton, CA (US)

Correspondence Address: SCHWEGMAN, LUNDBERG & WOESSNER, P.A., P.O. BOX 2938, MINNEAPOLIS, MN, 55402, US

(73) Assignee: AT&T Knowledge Ventures, L.P.

(21) Appl. No.: 11/700,710

(22) Filed: Jan. 30, 2007

(51) Int. Cl. H04L 12/56

(52) U.S. Cl. 370/401

(57) ABSTRACT

System and method to collect data from customer premise equipment (CPE) are provided. According to example embodiments disclosed herein, there is provided system and method allowing CPE to be queried by a CPE management system (CMS) via commands originated from a CPE data collection system. A system according to an example embodiment may include CPE, a CMS, and a CPE data collection system. The CMS system may transmit commands to query CPE; and the CPE may receive the commands and respond by sending stored data to the CMS. The received data by the CMS may be transferred to the CPE data collection system. The CPE may comprise a transceiver module to receive commands from the CMS, the commands originated from the CPE data collection system and to transmit stored data to the CMS; and a memory device to store data.

### TECHNICAL FIELD

The inventive subject matter relates generally to data communication system, and more specifically to systems and methods for collecting data from customer premise equipment.

### BACKGROUND

Internet system providers typically install a large number of customer premise equipment (CPE) at customer locations to provide various Internet services. For example, Broadband cable or Digital Subscriber Line (DSL) modems to provide high speed data access, Set-top Box (STB) units to provide Internet Protocol television (IPTV), and Residential Gateways to allow connecting local area network (LAN) to the Internet. Service providers typically collect customer level statistics from network elements (NE). Each network element typically serves a number of CPE and may have limitation on the amount of data stored.

### BRIEF DESCRIPTION OF THE DRAWINGS

Some embodiments are illustrated by way of example and not limitation in the figures of the accompanying drawings in which:

FIG. 1 illustrates an example embodiment of a high level system architecture of an Internet service provider collecting CPE stored data;

FIG. 2 illustrates an example embodiment of a system for collecting and managing CPE stored data;

FIGS. 3 illustrates an example embodiment of a CPE management system collecting CPE stored data and transferring the data to a CPE data collection system;

FIG. 4 illustrates one example embodiment of a CPE data collection system;

FIG. 5 illustrates an example embodiment of customer premise equipment supporting a number of local area network (LAN) devices;

FIG. 6 illustrates an example embodiment of a method for collecting CPE stored data;

FIG. 7 illustrates an example embodiment of a method for transmitting stored data to a management system by a customer premise equipment in response to commands received from the management system;

FIG. 8 is a sequence diagram illustrating an example embodiment of a method for collecting CPE stored data and transferring data to a CPE data collection system.

FIG. 9 is a block diagram illustrating a diagrammatic representation of a machine in the example form of a computer system.

### DETAILED DESCRIPTION

Example methods and systems to collect customer premise equipment (CPE) stored data by a CPE data collection system through a management system (e.g. CPE Management System (CMS)) are described. In the following description, for purposes of explanation, numerous specific details are set forth in order to provide a thorough understanding of example embodiments. It will be evident, however, to one skilled in the art that the present invention may be practiced without these specific details.

A method and a system for collecting CPE stored data are provided. In one example embodiment, a CPE data collection system (described below) may interface, in multiple concurrent sessions, with a management system (further described below) to spawn commands to a plurality of customer premise equipment (described below). The management system may transmit commands, via a network, to query the plurality of customer premise equipment and receive, via the network, data stored by the customer premise equipment in response to the commands. In an example embodiment, the commands may include support for a whole object data retrieval format discussed below. According to example embodiments, a CPE may include a broadband cable modem, an asymmetric digital subscriber line (ADSL) modem, a set-top box, or a residential gateway.

According to example embodiments, transmitting commands by the CPE management system and receiving stored data from the customer premise equipment may take place in real time. The CPE management system may query a plurality of CPE in parallel. The CPE management system may use a CPE Wide Area Network (WAN) Management Protocol (aka, TR-069; described in DSL Forum Technical Report TR-069, http://www.dslforum.org/techwork/tr/TR-069.pdf) to communicate with the customer premise equipment. Transmitting commands to the CPE and receiving stored data from the CPE may be performed over a secure channel.

The advantage of collecting CPE stored data to collecting customer level statistics from network elements (NE) is that each network element may serve a number of CPE and may have limitation on the amount of data it may store; whereas, a CPE may only serve one customer and have capacity to store more granular network data. In addition, a CPE also may store customer data (e.g. local network data and user information) which is not available on network element. The data may be used for real time trouble shooting, capacity and performance management, network planning and customer marketing etc.

A number of measures may be implemented in order to enable the system to collect data from a large number of CPE in a limited time window. The CPE may be able to support very efficient data retrieval. For example, the CPE may use DSL forum standard TR-069 tree data model. In this model the data can be retrieved as either individual element, or whole object (whole branch or whole tree), where the data from all leaves may be collected at the same time. The whole object data retrieval format may be used in bulk data collection; whereas the individual element support may be required for on-demand trouble shooting. In addition, as discussed in more detail below, the CPE management system may be equipped with load balances to be able to support a large number of parallel sessions (e.g. contiguous sequence of transactions between a CPE and the CPE management system). Also the CPE data collection system may interface with the management system in multiple parallel sessions to spawn commands to collect stored data from multiple customer premise equipments at the same time. With multi-threading support, the CPE stored data collector system may spawn as many threads as needed depending on the availability of computer hardware resources.

In example embodiments, the commands received by the management system from the CPE data collection system may include customer identification data related to a customer associated with the CPE. The commands may also include a set of instructions to be executed by the CPE to cause CPE to transmit data to the CPE management system. In one example embodiment, the CPE identification data may be provided to the CPE data collection system by a CPE identification database. In another example embodiment, the CPE identification data may be provided by a CPE activation system. The CPE activation system may hold the data collected by the Internet service provider from customers at the time of customer service activation.

According to an example embodiment, customer premise equipment may receive commands originated by a CPE management system to query the customer premise equipment and, in response to the received commands, transmit data to the CPE management system. The CPE may periodically collect data related to the devices connected to the CPE via a local area network. The CPE may store the collected data in a memory device installed in the CPE. The data transmitted by the CPE to the CPE management system may be retrieved from the memory device, upon receiving commands from the CPE management system.

Compared with data collection from network elements, CPE stored data collection may provide the following benefits: 1. CPE stored data collection may supply richer data set including customer data in addition to network data. 2. CPE stored data collection may use the Internet and may not need to build a management network, as the network element data collection does. 3. CPE stored data collection may use whole object retrieval format (retrieve a complete set of CPE stored data in one command) to greatly speed up the data collection and minimize network traffic. 4. Parallel CPE stored data collection sessions and load balanced CPE management system with Hyper-Text Transport Protocol (HTTP) based Open Source Software (OSS) Application Programming Interface (API) minimize the time duration to collect stored data from a large number of CPE.

In the following detailed description, reference is made to the accompanying drawings that form a part hereof, and in which are shown, by way of illustration, specific embodiments in which the inventive subject matter may be practiced. It is understood that other embodiments may be utilized and structural changes may be made without departing from the scope of the inventive subject matter. The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning may be clear from its use in the context of the description.

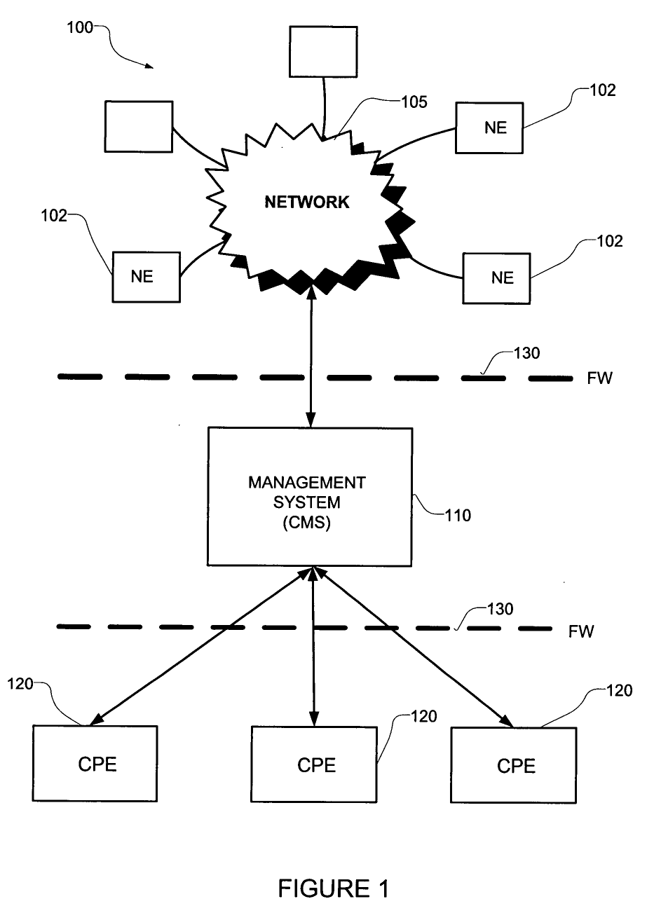

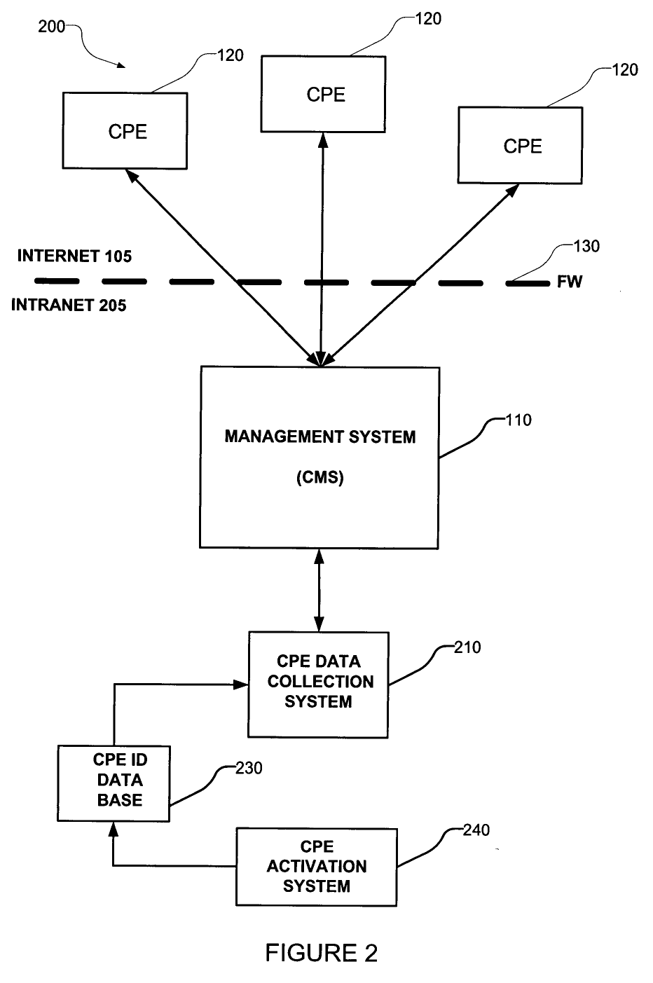

FIG. 1 illustrates an example embodiment of high level system architecture 100 of an Internet service provider collecting CPE stored data. Example network element(s) (NE) 102 and a CPE management system (CMS) 110 are communicatively connected via a network 105 (e.g. the Internet). The CPE management system 110 may communicate through a network (e.g. network 105) with a plurality of customer premise equipment (CPE) 120. The firewall (FW) 130 protects the management system 110 and other systems (shown in FIG. 2) connected to the management system 110, via Intranet 205, from any unauthorized access.

According to an example embodiment, the CPE management system 110 may use CPE WAN Management Protocol to communicate with a plurality of customer premise equipments. The example CPE management system 110 and the CPE WAN Management Protocol are capable of supporting concurrent communication with a plurality of customer premise equipment 120.

The customer premise equipment 120, according to example embodiments, may include a broadband cable modem, an asymmetric digital subscriber line (ADSL) modem, a set-top box, or a residential gateway. The customer premise equipment 120 may support devices such as: personal computers, Internet Protocol television (IPTV), fax machine machines, Voice over Internet Protocol (VOIP) modems, etc. connected through a local area network.

FIG. 2 illustrates an example embodiment of a system 200 for collecting and managing CPE stored data. In the example embodiment shown, the management system 110 may collect stored data from the customer premise equipment 120, via the network (e.g. network 105) through the firewall 130. In one example embodiment, the communication between the management system 110 and customer premise equipment 120 may take place over a CPE WAN Management Protocol. According to example embodiments, the management system 110 may query a plurality of customer premise equipment 120 in parallel sessions. The management system 120 may also receive stored data concurrently from a plurality of customer premise equipments.

The management system 110 may receive customer identification data and instructions to query plurality of the customer premise equipment 120, from a CPE data collection system 210. The management system 110 may transfer the collected CPE stored data, originated from the plurality of customer premise equipment, to the CPE data collection system 210. The CPE data collection system 210 may search CPE identification (ID) database 230 to find the identification data related to customers associated with the plurality of CPE. The CPE ID database 230 may be fed by CPE activation system 240. The CPE activation system 240 may have access to the customer provision information acquired at the time of service activation by the Internet service provider.

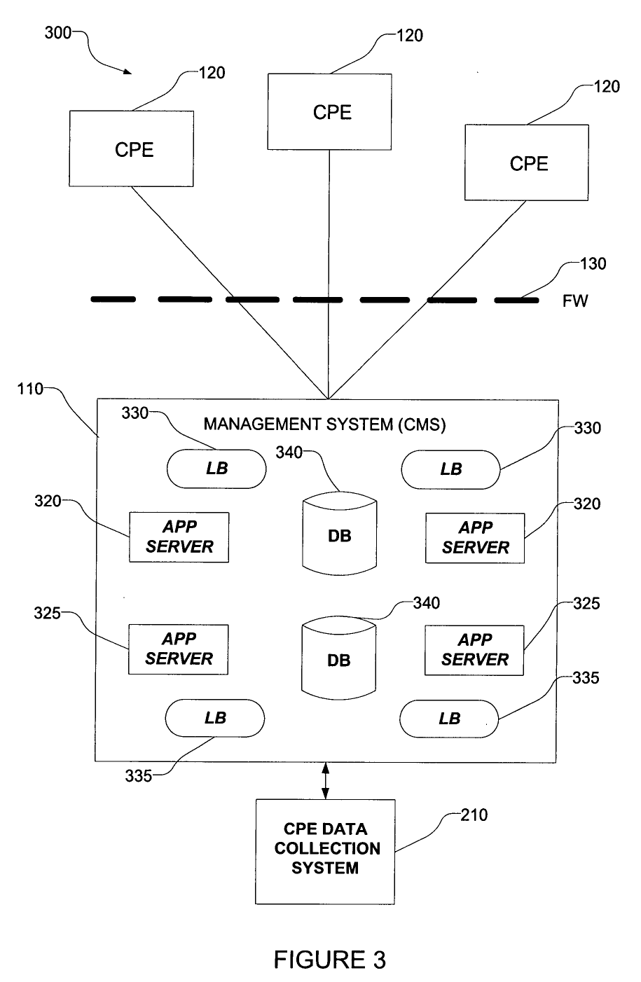

FIG. 3 is a block diagram 300, illustrating an example embodiment of a CPE management system collecting CPE stored data and transferring the data to a CPE data collection system. As shown in the figure, the management system 110 may support multiple customer premise equipments 120 in parallel sessions. The firewall 130 protects the management system 110 and other systems connected to the management system 110, via the Intranet 205, from the unauthorized access by any system connected to the network of the customer premise equipments (e.g. network 105 of FIG. 1).

The management system 110 may include load balancers (LB) 330 and 335, application (APP) servers 320 and 325, and databases (DB) 340. The load balances 330 and 335 may be provided in redundancies in both sides of the management system 110 to support parallel session communication between the plurality of customer premise equipment 120 and the CPE data collection system 210. The management system 110 is also equipped with redundancies in application servers 320 and 325 and databases 340 to be prepared for data handling and storage requirements of concurrent communication with multiple customer premise equipment. Parallel CPE stored data collection sessions and load balanced management system 110 with HTTP based OSS API minimizes the time duration to collect data from a large number of customer premise equipment 120.

On the CPE side the application servers 320 support the communication with the plurality of the customer premise equipment 120. This support may include transmitting commands to query the customer premise equipment 120 and receiving stored data from the customer premise equipment 120. On the CPE data collection system 210 sides, the application servers 325 may handle communication of commands and CPE identification data originated from the CPE data collection system 210 and transferring of data stored by the plurality of customer premise equipment 120 to the CPE data collection system 210.

According to example embodiments, the databases 340 may store CPE identification data related to customer premise equipment 120 associated with customers provisioned by the Internet service provider. The database 340 may also store CPE reboot information received from the customer premise equipment 120. The fast retrieval of the data from the databases 340 may facilitate parallel handling of the plurality of customer premise equipment 120.

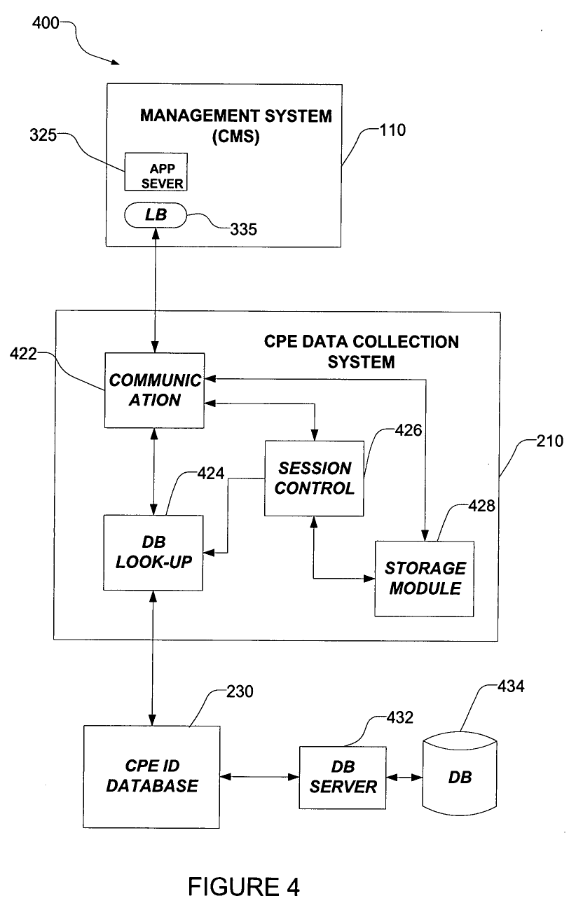

FIG. 4 is a block diagram 400 illustrating an example embodiment of a CPE data collection system. The CPE data collection system 210, the CPE management system 110, a CPE ID database 230 and a database server 432 may be connected together via the Intranet 205. Application server(s) 325 and load balance(s) 335 may handle the communication between the CPE management system 110 and the CPE data collection system 210. The CPE data collection system 210 may include a communication module 422, a session control module 426, a database look-up module 424 and a storage module 428.

The communication module 422 may receive data stored by the customer premise equipment 120 through the management system 110 and transfer the received CPE stored data to the storage module 428. In addition, the communication module 422 may transfer commands received from the session control module 426 to the management system 110 to be used by the management system 110 to query the customer premise equipment 120. The communication module 422 may also receive CPE ID data from the database (DB) look-up module 424 and transfer the CPE ID data to the management system. The management system 110 may use the CPE identification data for accessing the customer premise equipment 120 in order to query the customer premise equipment 120 and collect the customer premise equipment 120 data.

The session control module 426 may play a control and monitoring role on the communication module 422, database look-up module 424 and storage module 428. The session control module 426, as a coordinator, may exert control over the timing of events and activities of the other modules of the CPE data collection system 210. The storage module 428 may be accessed by the communication module 422 for data storage or retrieval. The look-up module 424 may search CPE ID database 230 for any CPE identification data that might be required to allow the management system 110 to access and query the customer premise equipment 120. The CPE ID database 230 may need to access other database(s) such as database 434 via database server 432, in order to obtain the data requested by the database look-up module 424.

The received data by the CPE data collection system 210, originated from the customer premise equipment 120, may include stored customer data (e.g. data related to the local network connected to the CPE and end-users data related to the devices connected to the CPE local network) which is not available on typical network elements (e.g. 102). The data may also include data related to the capacity of a loop from the customer premise equipment 120 to a provider network 105; or data related to the performance of a loop from the customer premise equipment 120 to a provider network 105.

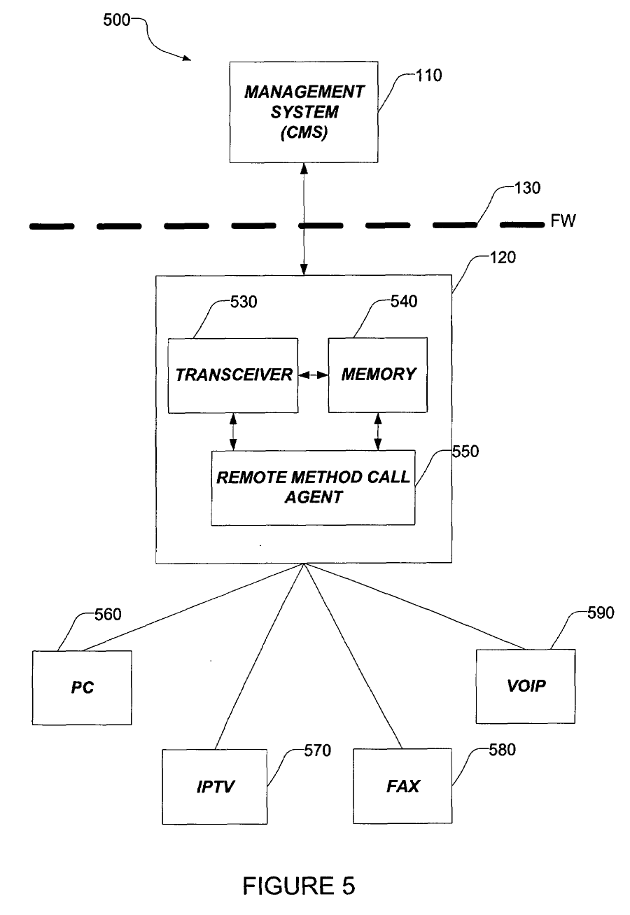

FIG. 5 is a block diagram 500, illustrating an example embodiment of customer premise equipment supporting a number of local area network (LAN) devices. The customer premise equipment 120 is connected to the management system 110 via a network (e.g. network 105) through the firewall 130. The firewall 130 may protect the management system 110 and the other systems connected to the management system 110 via the Intranet 205 from unauthorized access by any system connected to the CPE network (e.g. network 105). The customer premise equipment 120 may provide high speed data access to a series of end-user devices such as personal computer (PC) 560, IPTV 570, fax machine 580 and VOIP 590, via a local area network.

According to an example embodiment, the remote system 120 may include a transceiver 530, a memory unit 540 and a remote method call agent 550. The transceiver 530 may receive commands originated from the CPE data collection system 210 through the management system 110 and deliver the commands to the remote method call agent 550 for execution. The transceiver 530 may also receive data from the memory unit 540 and transmit the received data to the management system 110, via a network (e.g. network 105). In an example embodiment, the transmission of data from the remote system 120 to the CPE management system 110 may take place over the CPE WAN Management protocol (aka, TR-069). The transceiver 530 may also handle data communication with local network devices such as, PC 560, IPTV 570, fax machine 580 and VOIP 590.

The memory unit 540 may be a semiconductor memory storing numerous valuable data. The stored data may include local network data or WAN network data. The local network data may include local network capacity and performance data and end-user device data, which may not be available on a typical network element 102. The customer premise equipment 120 may have capacity to store more granular network data than network element 102, because it only deal with one customer, whereas, the network element 102 may cope with a large number of network customers. Therefore, the customer premise equipment 120 may store statistics of capacity and performance of the loop from the customer premise equipment 120 to the provider network 105, which is normally collected by Internet service providers (ISP) and stored in network element(s) 102. The customer premise equipment 120 may be able to support very efficient data retrieval. For example, the customer premise equipment 120 may use DSL forum standard TR-069 tree data model. In this model the data can be retrieved as individual element, or whole object (whole branch or whole tree) at the same time. The whole object retrieval may be used in bulk data collection; whereas the individual element support may be required for on-demand trouble shooting.

The remote method call agent 550 may receive instruction from the transceiver 530, originated from the management system 110, and execute the instructions. In one example embodiment, the instructions, upon execution by the remote method call agent 550, may cause specified data to be retrieved from the memory unit 540 and delivered to the transceiver 530, for transmission to the management system 110. In another example embodiment, the instructions executed by the remote method call agent 550 may cause collection of data from the local network devices (e.g. PC 560, IPTV 570, fax machine 580, or VOIP 590) via the transceiver 530. According to an example embodiment, the customer premise equipment 120 may include a Hyper-Text Transport Protocol Secure (HTTPS) server to support secured HTTP connections.

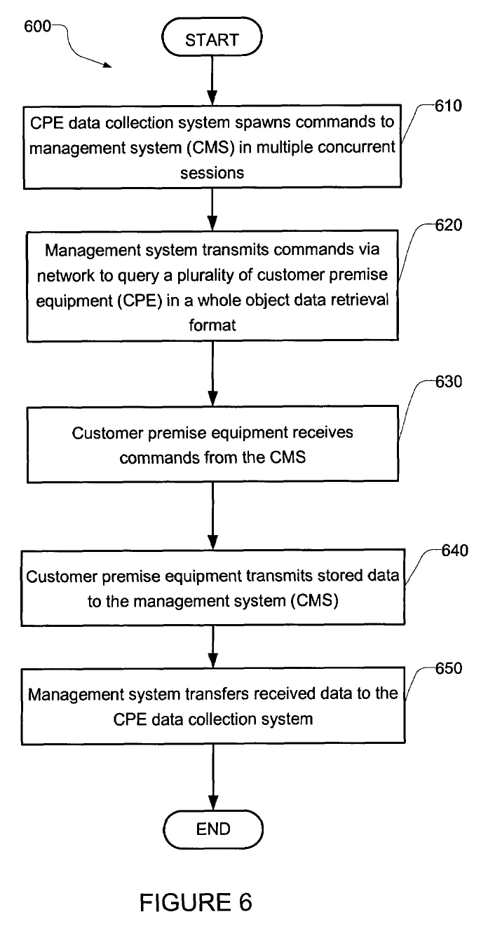

FIG. 6 is a flow diagram illustrating an example embodiment of a method 600 for collecting CPE stored data. Method 600 starts at operation 610, where the CPE data collection system 210 may interface with the management system 110 in multiple parallel sessions to spawn commands to be transmitted concurrently to a plurality of customer premise equipment 120. The management system 110, at operation 620 may then transmit commands, via the network 105, to query the customer premise equipment 120. The commands may include support for whole object data retrieval format. The customer premise equipment 120, at operation 630, may receive commands from the management system 110; and at operation 640, the customer premise equipment 120 may transmit stored data to the management system 110 using whole object data retrieval format. The management system 110, at operation 650, transfers the data received from the customer premise equipment 120 to the CPE data collection system 210.

According to one example embodiment, the management system 110 may query multiple customer premise equipments 120, concurrently. In one example embodiment the management system 110 may use CPE WAN Management protocol for communication with customer premise equipment 120. The commands received by the customer premise equipment may include instructions to be executed by the customer premise equipment 120. The execution of the instructions by the customer premise equipment 120 may cause the customer premise equipment to send stored data to the management system 110.

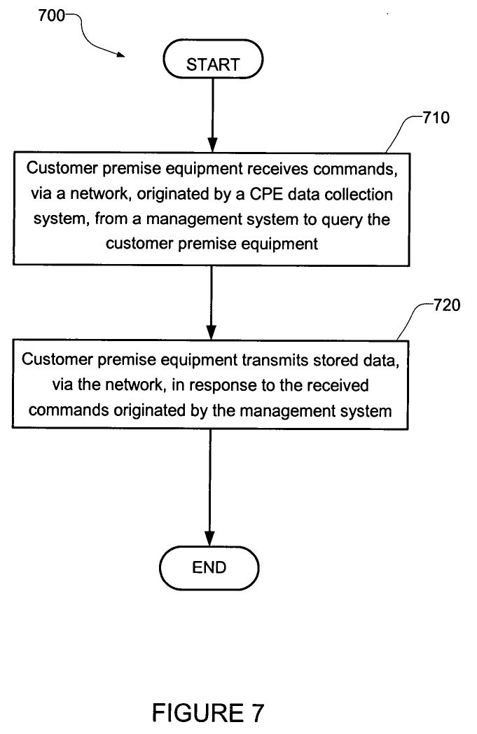

FIG. 7 is a flow diagram illustrating an example embodiment of a method 700 for transmitting stored data to a management system by customer premise equipment, in response to commands received from the management system. The method 700 starts at operation 710, where the customer premise equipment 120 may receive commands, via the network 105, originated by a CPE data collection system 210, from the management system 110 to query the customer premise equipment 120. Next, at operation 720, the customer premise equipment 120 may respond to the commands received from the management system 110, by transmitting data, via the network 105, to the management system 110.

According to one example embodiment, the customer premise equipment 120, using the remote method call agent 550, may execute the commands received from the management system 110. The execution of commands may cause the customer premise equipment 120 to retrieve from the memory unit 540 and transmit the data using the transceiver 530 to the management system 110.

The data transmitted to the management system 110 may include local network data or WAN network data. The local network data may include local network capacity and performance data and end-user device data, which may not be available on the network element 102. The customer premise equipment 120 may have capacity to store more granular network data than network element 102, because it only deal with one customer, whereas, the network element 102 may cope with a large number of network customers. Therefore, the customer premise equipment 120 may store statistics of capacity and performance of the loop from the customer premise equipment 120 to the provider network 105, which is normally collected by Internet service providers (ISP) and stored in network element(s) 102. The customer premise equipment 120 may be able to support very efficient data retrieval. For example, the customer premise equipment 120 may use DSL forum standard TR-069 tree data model. In this model the data can be retrieved as individual element, or whole object (whole branch or whole tree) at the same time. The whole object retrieval may be used in bulk data collection where the data from every leaf of the tree is collected at the same time; whereas the individual element support may be required for on-demand trouble shooting.

According to an example embodiment, for transmission of data, the customer premise equipment 120 may use the CPE WAN Management Protocol. The CPE WAN Management Protocol provides support for customer premise equipment 120 to make available information that the management system 110 may request to monitor the status and performance statistics related to the customer premise equipment 120. The protocol also provides support for customer premise equipment 120 to make available information that the management system 110 may use to diagnose connectivity or service issues.

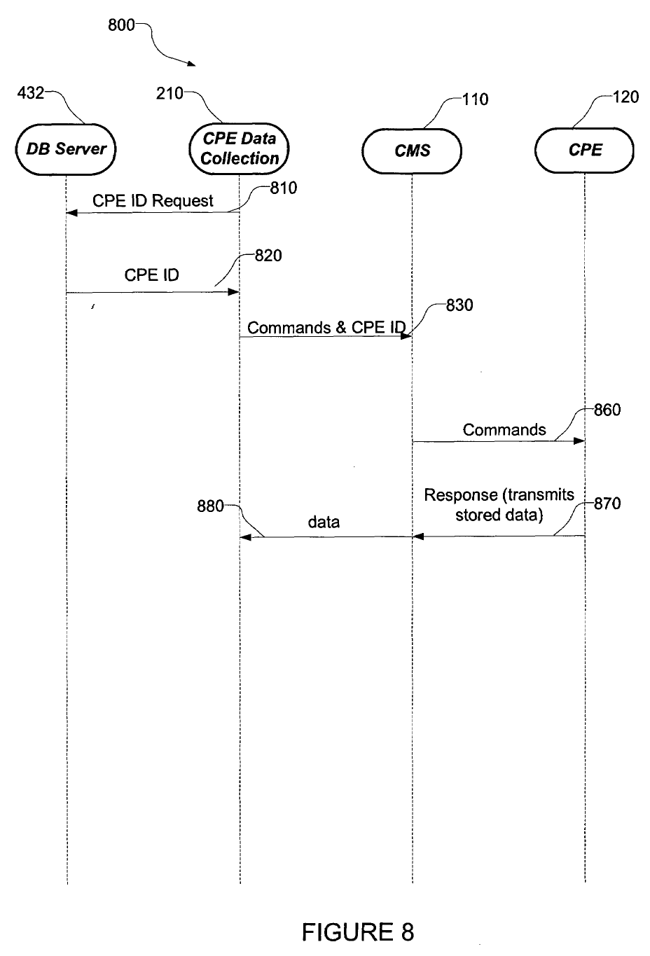

FIG. 8 is a sequence diagram 800, illustrating an example embodiment of a method for collecting CPE stored data and transferring data to a CPE data collection system. The sequence of operations starts at step 810, where a CPE ID request may be made by the CPE data collection system 210 to the database server 432 to receive CPE identification information. The Database server 432 may retrieve the requested information from the database 434 and, at step 820, deliver the information to the CPE data collection system 210. At step 830, the CPE data collection system 210 may send commands as well as CPE identification information to the management system 110. The management system 110, at step 860, may transmit the commands, originated from the CPE data collection system 210, to one or more customer premise equipment 120, for which access certificate has been obtained. The commands will be executed by the customer premise equipment 120 and, in response, at step 870 the requested data is transmitted to the management system 110. The management system 110 may then, at step 880, transfer the data to the CPE data collection system 210.

According to an example embodiment, the communication between the management system 110 and the customer premise equipment 120 may take place, via a network (e.g. network 105), over the CPE WAN Management protocol. The collection of CPE stored data, by the management system 110, from a plurality of customer premise equipment 120, may be performed in parallel.

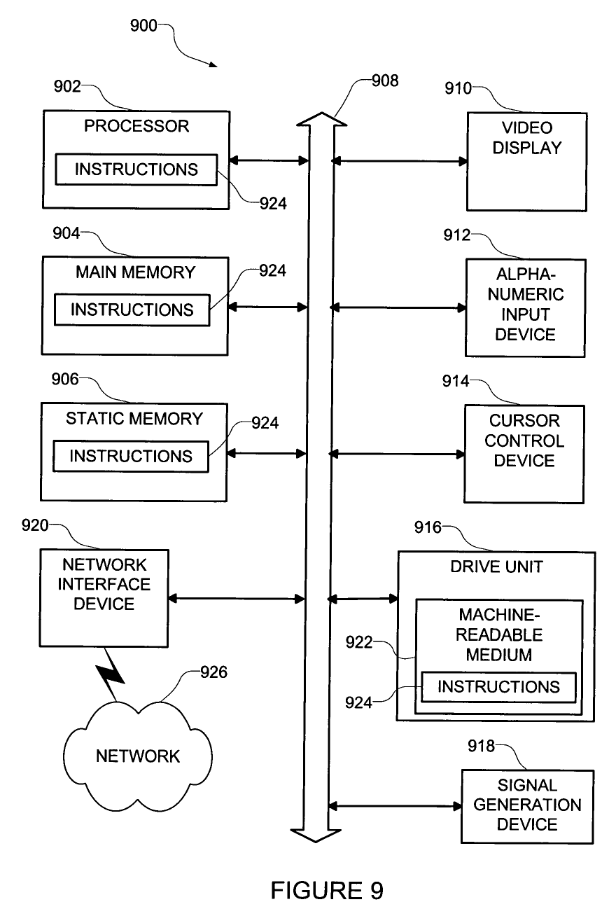

FIG. 9 shows a diagrammatic representation of machine in the example form of a computer system 900 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD), or a cathode ray tube (CRT)). The computer system 900 may also include an alphanumeric input device 912 (e.g., a keyboard), a user interface (UI) navigation device 914 (e.g., a mouse), a disk drive unit 916, a signal generation device 918 (e.g., a speaker) and a network interface device 920.

The disk drive unit 916 may include a machine-readable medium 922 on which is stored one or more sets of instructions and data structures (e.g., software 924) embodying or utilized by any one or more of the methodologies or functions described herein. The software 924 may also reside, completely or at least partially, within the main memory 904 and/or within the processor 902 during execution thereof by the computer system 900; the main memory 904 and the processor 902 also constituting machine-readable media.

The software 924 may further be transmitted or received over a network 926 via the network interface device 920 utilizing any one of a number of well-known transfer protocols (e.g., HTTP).

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media.

Thus, a method and system to collect customer premise equipment have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
transmitting commands, originated from a customer premise equipment (CPE) data collection system, by a management system to query a CPE via a network; and
receiving, via the network, data stored by the CPE in response to the transmitted commands.

2. The method of claim 1, wherein the transmitting further includes identifying the management system as a CPE management system (CMS).

3. The method of claim 1, further comprising interfacing between the CPE data collection system and the management system in multiple concurrent sessions and the commands originated from the CPE data collection system being able to query a plurality of additional CPE in a whole object data retrieval format.

4. The method of claim 1, wherein transmitting commands further includes concurrently transmitting the commands to a plurality of additional CPE.

5. The method of claim 1, wherein transmitting commands and receiving data are performed periodically.

6. The method of claim 1, wherein receiving data further includes concurrently receiving data from a plurality of additional CPE in a whole object data retrieval format.

7. The method of claim 1, wherein transmitting commands and receiving data are dynamically performed in real time.

8. The method of claim 1 further comprising, receiving customer identification data from a CPE identification database at the CPE data collection system, wherein the received data originating from a CPE activation system

9. The method of claim 6 further comprising, concurrently receiving, at the CPE data collection system, the data received by the management system originated from the plurality of additional CPE.

10. The method of claim 1, wherein the transmitting commands to the CPE and the receiving data from the CPE are performed over a secure communication channel.

11. The method of claim 1 further comprising identifying the CPE as being one or more of the following:
an asymmetric digital subscriber line (ADSL) modem;
a set-top box (STB); and
a residential gateway.

12. The method of claim 1 further comprising identifying the commands as being one or more of the following:
customer identification data related to a customer associated with the CPE; and
a set of instructions to be executed by the CPE.

13. The method of claim 1 further comprising, identifying the data as being one or more of the following:
data related to a capacity of a loop from the CPE to a provider network,
data related to a performance of a loop from the CPE to a provider network,
data related to a local network connected to the CPE, and
end-users data related to devices connected to the CPE via the local network.

14. A method comprising:
receiving commands, originated from a customer premise equipment (CPE) data collection system and transmitted by a management system, to query CPE via a network; and
transmitting, via the network, data stored by the CPE in response to the received commands transmitted by the management system.

15. The method of claim 14, wherein receiving commands and transmitting data are performed periodically and data is retrieved in a whole object data retrieval format.

16. The method of claim 14, wherein receiving commands from the management system and transmitting data from the customer premise equipment are performed using a CPE Wide Area Network (WAN) Management Protocol.

17. The method of claim 14, further comprising identifying the CPE as being one or more of the following:
an asymmetric digital subscriber line (ADSL) modem;
a set-top box (STP); and
a residential gateway.

18. A system comprising:
a data collection system to send commands to a management system, the data collection system to receive data from the management system; and
the management system comprising:
a communication module to transmit the received commands from the data collection system, via a network, to customer premise equipment (CPE),
the communication module to receive data stored by a particular CPE, via the network, from the particular CPE, responsive to the commands transmitted by the communication module, and
the communication module to send the received data originated from the particular CPE to the data collection system.

19. The system of claim 18, wherein the management system is a CPE management system (CMS).

20. The system of claim 18, wherein the communication module is to transmit commands to the CPE and receives data from the CPE using a CPE Wide Area Network (WAN) Management Protocol.

21. The system of claim 18, wherein the data collection system is a CPE data collection system and the CPE data collection system is to receive customer identification data from a CPE identification database, the received data originating from a CPE activation system.

22. The system of claim 21, wherein the CPE data collection system is to interface with the management system in multiple concurrent sessions to send commands to the management system, the commands to be transmitted concurrently, by the management system, to a plurality of additional CPE and the commands to be able to query the plurality of additional CPE in a whole object data retrieval format.

23. The system of claim 18, wherein the management system is to include load balances to support parallel communications with a plurality of additional CPE.

24. The system of claim 18, wherein the management system is to include databases to store customer related data.

25. A customer premise equipment (CPE) comprising:
a transceiver module to receive commands, via a network, from a management system,
the transceiver module to transmit stored data, via the network, to the management system, responsive to the received commands from the management system, originated from a CPE data collection system; and
a memory device to store data.

26. The CPE of claim 25 including a Remote Procedure Call (RPC) Agent to handle the commands received by the transceiver module, the commands to support a whole object data retrieval format.

27. The CPE of claim 25 including a Hyper-Text Transport Protocol Secure (HTTPS) service.

28. The CPE of claim 25, wherein the transceiver is to receive commands and to transmit data using a CPE wide Area Network (CPE WAN) Management Protocol.

29. A machine-readable medium embodying instructions, the instructions, when executed by a machine, causing the machine to concurrently:
send commands to query a plurality of customer premise equipment (CPE), from a CPE data collection system to a CPE management system (CMS);
receive data related to the plurality of customer premise equipments, by the CPE data collection system from the CMS;
transmit the received commands from the CPE data collection system, via a network by a communication module, to the plurality of CPE and
receive data, via the network by the communication module, from the plurality of CPE, responsive to the commands transmitted by the CMS; and
send the data, by the communication module, to the CPE data collection system.
